(19) United States
(12) Patent Application Publication
(10) Pub. No.: US 2017/0269868 A1
(43) Pub. Date: Sep. 21, 2017

(54) INFORMATION PROCESSING APPARATUS, STORAGE SYSTEM, COMPUTER-READABLE RECORDING MEDIUM, AND INFORMATION PROCESSING METHOD

(71) Applicant: FUJITSU LIMITED, Kawasaki-shi (JP)

(72) Inventors: Akimasa Yoshida, Nagoya (JP); Keiya Ishikawa, Kawasaki (JP)

(73) Assignee: FUJITSU LIMITED, Kawasaki-shi (JP)

(21) Appl. No.: 15/429,981

(22) Filed: Feb. 10, 2017

(30) Foreign Application Priority Data
Mar. 15, 2016 (JP) 2016-050639

(51) Int. Cl. G06F 3/06; G06F 12/0802

(52) U.S. Cl. CPC G06F 3/0646; G06F 12/0802; G06F 3/0608; G06F 3/0685; G06F 2212/60

(57) ABSTRACT

A cache holds, until a predetermined condition is satisfied, read data which is read, on the basis of a read request, from a storage device which has data including migration target data. A storage unit stores therein migration information which includes identification information and access date and time of the migration target data. A reading unit reads, on the basis of the migration information, the migration target data from the storage device in chronological order of the last access date and time and stores the migration target data in an area in the cache other than an area in which the migration target data has already been stored. A writing unit writes the migration target data stored in the cache to a storage device.

### CROSS-REFERENCE TO RELATED APPLICATION

This application is based upon and claims the benefit of priority of the prior Japanese Patent Application No. 2016-050639, filed on Mar. 15, 2016, the entire contents of which are incorporated herein by reference.

### FIELD

The embodiment discussed herein is related to an information processing apparatus, a storage system, a computer-readable recording medium, and an information processing method.

### BACKGROUND

In recent years, most business in corporation becomes systemized and an amount of data to be accumulated is increased at an accelerated pace. Furthermore, there is a need to store data for a long time in order to respond to compliance.

In order to cope with a rapid increase in the amount of data, if a plurality of physical storage devices is simply connected, an operation load is increased, which may possibly exerts a negative influence on an increase in cost and the reliability of storing data. Thus, in order to reduce the operation load, there is a proposed storage virtualization technology that creates a virtual storage pool in which a plurality of physical storage devices is virtually integrated and managed and that collectively uses the plurality of physical storage devices. In a description below, each of the physical storage devices included in the virtual storage pool is simply referred to as a “storage device”. Furthermore, the device that manages the virtual storage pool, such as creating a virtual volume, is referred to as a “virtual storage device”.

With the storage virtualization technology described above, a capacity can be cut out or returned from the virtual storage pool in accordance with a business status. Furthermore, if a capacity becomes insufficient, the entire capacity can be increased by newly adding a storage device to the virtual storage pool.

However, in a storage virtualization environment, if a storage device is added, an access load applied to physical disks may possibly be uneven due to deviation of data between devices. Thus, in order to uniform the access load, data relocation is performed between the existing storage devices and the added storage devices.

As such a data relocation technology, there is a conventional technology that performs, when a read request has been issued to migration target data, data relocation by reading the migration target data, sending the read migration target data to a higher-level device, and writing the read migration target data to the storage area at the migration destination. Furthermore, there is a conventional technology that compresses and relocates data that is not accessed for a long time. Furthermore, there is a conventional technology that increases relocation processing of data when an input/output (IO) load is low.

Patent Document 1: Japanese National Publication of International Patent Application No. 2012-531653

Patent Document 2: Japanese Laid-open Patent Publication No. 2010-152516

Patent Document 3: Japanese Laid-open Patent Publication No. 2007-94994

However, if data relocation is performed, there is a problem in that the network load between the storage device and the virtual storage device is increased and the I/O performance with respect to the physical disk is degraded.

Furthermore, even if the conventional technology that performs data relocation by using a read request is used, because data migration is not performed unless the read request is issued, if an amount of data to be migrated is great when, for example, a storage device is added, it may possibly take time to perform data relocation. Furthermore, even if the conventional technology that relocates the data that is not accessed for a long time is used, it takes time to obtain un-accessed data and thus it is difficult to reduce the time taken to perform data relocation. Furthermore, even if the conventional technology that increases the process of data relocation when the I/O load is low is used, because all of the pieces of data are read after the I/O load is decreased, it may possibly take time to perform data relocation.

### SUMMARY

According to an aspect of an embodiment, an information processing apparatus includes: a cache that holds, until a predetermined condition is satisfied, read data which is read, on the basis of a read request, from a migration source storage device which has data including migration target data; a storage unit that stores therein migration information which includes identification information and access date and time related to the migration target data; a reading unit that reads, on the basis of the migration information, the migration target data from the migration source storage device in chronological order of the last access date and time and that stores the migration target data in an area in the cache other than an area in which the migration target data has already been stored; and a writing unit that writes the migration target data stored in the cache to a migration destination storage device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating an example of a storage system before storage devices are added;

FIG. 2 is a schematic diagram illustrating an example of the storage system in a state in which storage devices are added;

FIG. 3 is a block diagram illustrating a virtual storage device;

FIG. 4 is a schematic diagram illustrating an example of a migration target data table;

FIG. 5 is a flowchart illustrating the flow of a process of creating a migration target data table performed by the virtual storage device according to an embodiment;

FIG. 6 is a processing sequence diagram in the storage system according to the embodiment when a read request is generated;

FIG. 7 is a processing sequence diagram of data relocation performed in the storage system according to the embodiment; and

FIG. 8 is a schematic diagram illustrating the hardware configuration of the virtual storage device.

### DESCRIPTION OF EMBODIMENT

Preferred embodiments of the present invention will be explained with reference to accompanying drawings. Furthermore, the information processing apparatus, the storage system, the information processing program, and the information processing method disclosed in the present invention are not limited to the embodiments described below.

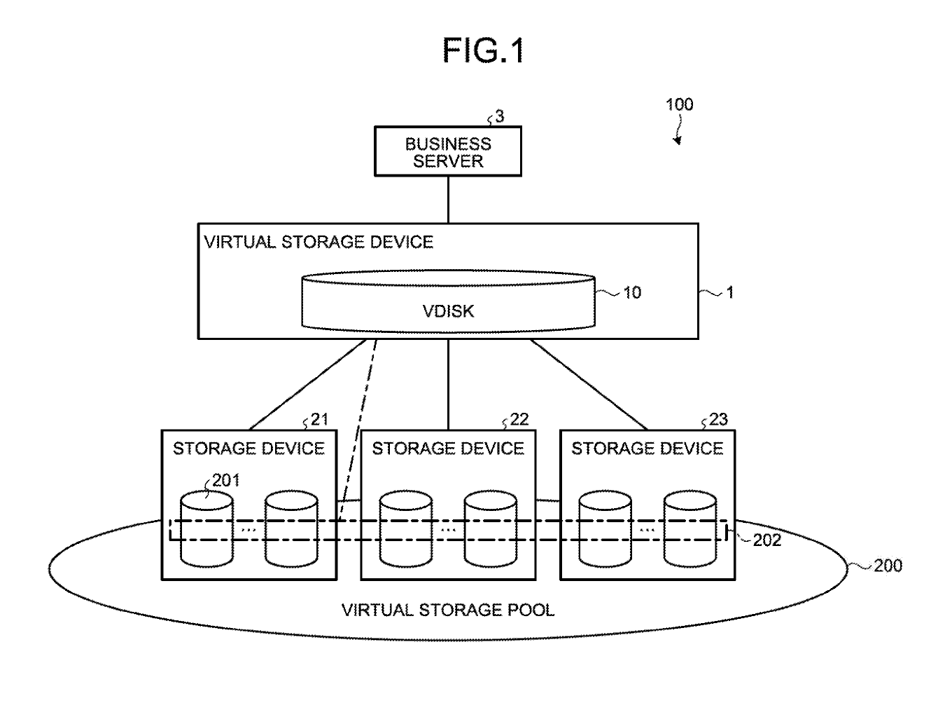

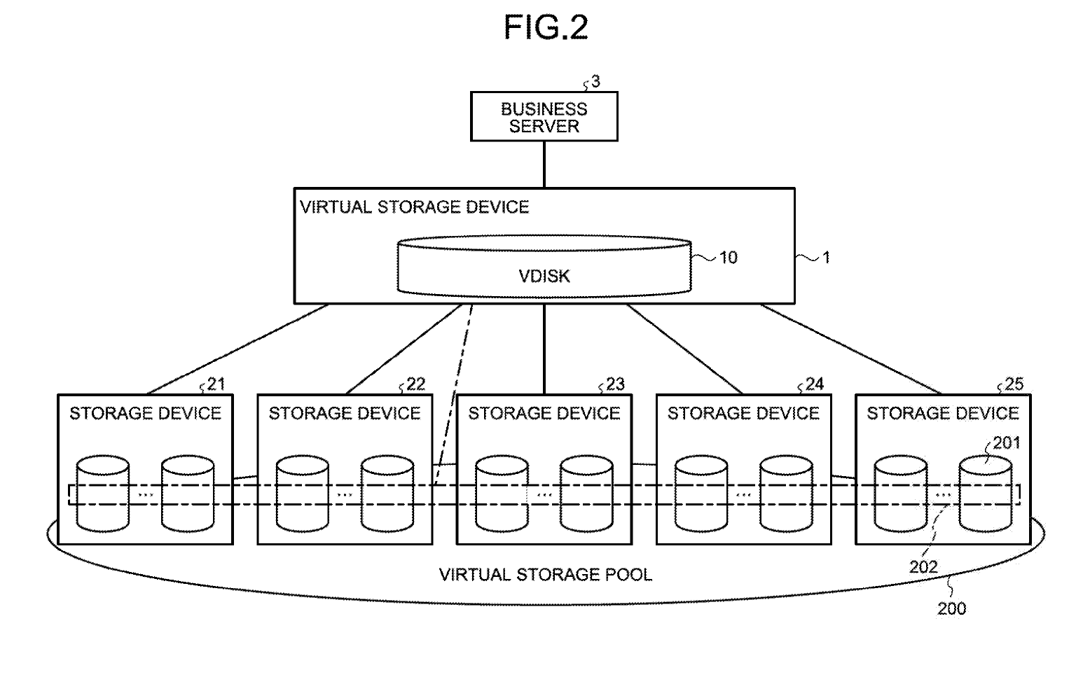

FIG. 1 is a schematic diagram illustrating an example of a storage system before storage devices are added. Furthermore, FIG. 2 is a schematic diagram illustrating an example of the storage system in a state in which storage devices are added.

A storage system 100 according to the embodiment includes a virtual storage device 1, storage devices 21 to 23, and a business server 3.

The business server 3 is a server that performs arithmetic processing by using data stored in a virtual disk (VDISK) 10 constructed by the virtual storage device 1 and that performs predetermined business. The business server 3 is connected to the virtual storage device 1. The business server 3 mentioned here corresponds to an example of an “arithmetic processing device”.

The storage devices 21 to 23 each include a plurality of disks 201. For example, the disk 201 is a hard disk. FIG. 1 illustrates a case in which three storage devices, i.e., the storage devices 21 to 23, are included; however, the number of the storage devices 21 to 23 is not particularly limited. The storage devices 21 to 23 are included in a virtual storage pool 200. Furthermore, the storage devices 21 to 23 each include the plurality of the disks 201. Furthermore, one or a plurality of striping sets 202 are constructed across the plurality of the disks 201 that are included in each of the storage devices 21 to 23. The storage devices 21 to 23 are connected to the virtual storage device 1.

The virtual storage device 1 constructs the single virtual storage pool 200 by assembling the storage devices 21 to 23. Furthermore, the virtual storage device 1 forms the striping set 202 by using the disks 201 included in each of the storage devices 21 to 23 that are included in the virtual storage pool 200. Then, the virtual storage device 1 uses the formed striping set 202 as a single virtual disk 10. The virtual storage device 1 provides the virtual disk 10 to the business server 3 and reads and writes data with respect to the virtual disk 10 in response to an instruction, received from the business server 3, to read or write data.

In the following, a case in which storage devices 24 and 25 are added to the storage system 100 that is in the state illustrated in FIG. 1 will be described with reference to FIG. 2.

The virtual storage device 1 incorporates the added storage devices 24 and 25 into the virtual storage pool 200. Furthermore, the virtual storage device 1 adds the disks 201 included in the storage devices 24 and 25 to the striping set 202 illustrated in FIG. 1 and newly constructs the striping set 202 by the disks 201 that are included in the storage devices 21 to 25. Then, the virtual storage device 1 provides the newly constructed striping set 202 as the virtual disk 10 to the business server 3. Namely, because the storage devices 24 and 25 are added, the capacity of the virtual disk 10 provided by the virtual storage device 1 to the business server 3 is increased. Here, in the embodiment, the two storage devices 24 and 25 are added to the virtual storage pool 200; however, the number of the storage devices to be added is not particularly limited.

When these storage devices 24 and 25 are added, the virtual storage device 1 migrates some data stored in the disks 201 in the storage devices 21 to 23 to the storage devices 24 and 25 equalizes the distribution of the data in each of the disks 201 that form the striping set 202. The virtual storage device 1 mentioned here corresponds to an example of a “storage management device”.

In the following, reading and writing of data performed by the virtual storage device 1 and migration of data will be described in detail. In a description below, the storage devices 21 to 23 that are the migration source of the data are collectively referred to as the “storage device 21”. Furthermore, the storage devices 24 and 25 that are the migration destination of the data are collectively referred to as the “storage device 24”.

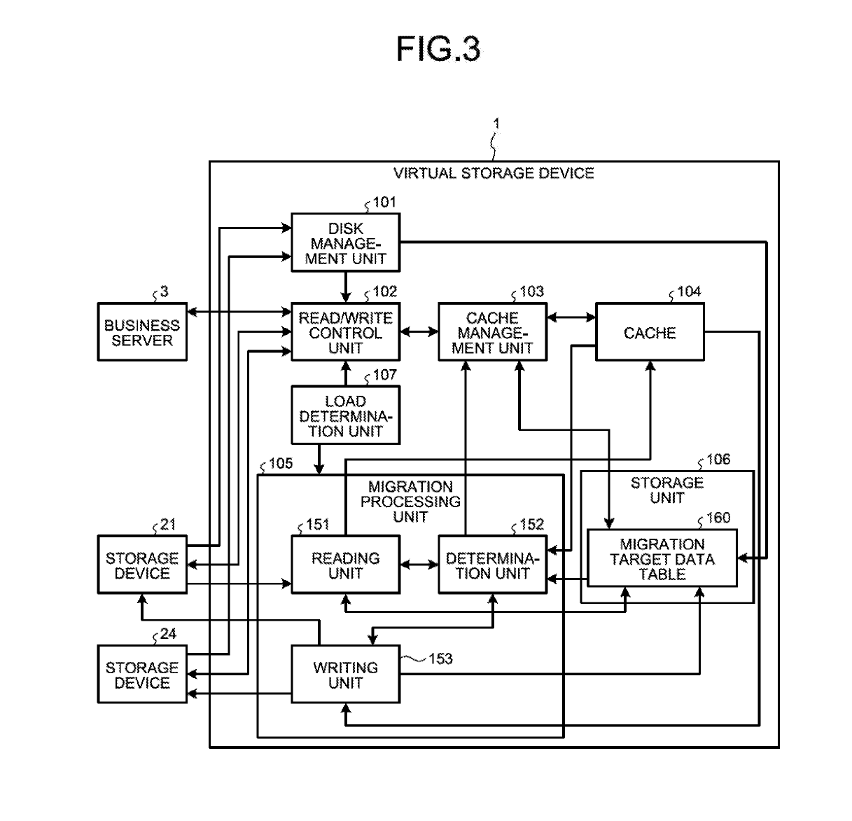

FIG. 3 is a block diagram illustrating the virtual storage device. As illustrated in FIG. 3, the virtual storage device 1 includes a disk management unit 101, a read/write control unit 102, a cache management unit 103, a cache 104, a migration processing unit 105, a storage unit 106, and a load determination unit 107.

The cache 104 is a storage device that temporarily stores therein the data read by the read/write control unit 102 from the storage device 21. Furthermore, the cache 104 holds the access date and time of each of the pieces of data to be stored as a time stamp.

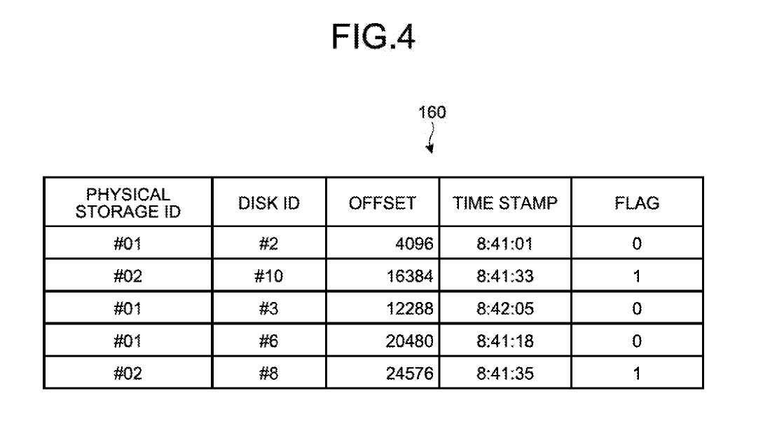

The storage unit 106 includes a migration target data table 160. FIG. 4 is a schematic diagram illustrating an example of a migration target data table. The migration target data table 160 is a table that represents, when the storage device 24 has been added, the data that is present before the addition, that has been added from the storage device 21, and that is to be migrated to the storage device 24. In the migration target data table 160, identification information on the storage device in which migration target data is stored, identification information on the disk, and the offset are registered. By using the information registered in the migration target data table 160, the migration target data can be specified.

Furthermore, in the migration target data table 160, a time stamp that indicates the latest access date and time of each of the pieces of the migration target data and a cache holding flag that indicates whether each of the pieces of the migration target data is present in the cache 104 are registered. In FIG. 4, the cache holding flag indicates that, if the flag is “1”, the subject migration target data is present in the cache 104, whereas, if the flag “0”, the subject migration target data is not present in the cache 104. The information registered in the migration target data table 160 mentioned here corresponds to an example of “migration information”.

The disk management unit 101 manages the configuration of the disks 201 included in the storage devices 21 and 24, such as the creation of the virtual storage pool 200, the construction of the striping set 202 and the virtual disk 10, or the like. The disk management unit 101 outputs the configuration information on the virtual disk 10 to the read/write control unit 102. Furthermore, if the storage device 24 is added, by using the disks 201 included in the added storage device 24, the disk management unit 101 newly forms the striping set 202 by using the disks 201 that are included in the storage devices 21 and 24 and newly forms the virtual disk 10. Furthermore, the disk management unit 101 outputs the configuration information on the formed virtual disk 10 to the read/write control unit 102.

Furthermore, if the disks 201 included in the storage device 24 have newly been added to the striping set 202, the disk management unit 101 specifies the data that is to be migrated from the storage device 21 that is present before the addition to the added storage device 24. Then, the disk management unit 101 acquires information on the specified data, i.e., the identification information on the storage device in which the subject data is to be stored, the identification information on the disk, and the offset. Then, the disk management unit 101 registers the acquired information in the migration target data table 160 that is included in the storage unit 106. In a description below, the storage device 21 that becomes the migration source of the data may sometimes be referred to as a “migration source storage device” and the storage device 24 that becomes the migration destination of the data may sometimes be referred to as a “migration destination storage device”.

The read/write control unit 102 acquires the configuration information on the virtual disk 10 from the disk management unit 101. Furthermore, in response to the instruction from the business server 3, the read/write control unit 102 reads and writes data from and to the virtual disk 10. The reading and the writing of data performed with respect to the virtual disk 10 is, in practice, the reading and the writing performed with respect to the storage devices 21 and 22.

Specifically, if the read/write control unit 102 receives a read request for data from the business server 3, the read/write control unit 102 instructs the cache management unit 103 to acquire the data that is requested by the read request. If the data requested by the read request is present in the cache 104, the read/write control unit 102 acquires the data requested by the read request from the cache management unit 103.

In contrast, if the data requested by the read request is not present in the cache 104, the read/write control unit 102 receives an error response from the cache management unit 103. If an error response is received, the read/write control unit 102 acquires, from the virtual disk 10, the data requested by the read request. More specifically, the read/write control unit 102 sends an acquisition request for the data that is requested by the read request to the storage device that stores therein the subject data from among the storage devices 21 and 24 that forms the virtual disk 10. Then, the read/write control unit 102 acquires the data requested by the read request from the storage device that has sent the acquisition request. Then, the read/write control unit 102 instructs the cache management unit 103 to store the acquired data in the cache 104. Furthermore, the read/write control unit 102 sends, to the business server 3, the data acquired as a response to the read request.

Furthermore, if the read/write control unit 102 receives a write request for data from the business server 3, the read/write control unit 102 stores the data requested by the write request in the virtual disk 10. Specifically, the read/write control unit 102 determines, from the state of the striping set 202, which one of the storage devices 21 and 24 that form the virtual disk 10 is used to store the data requested by the write request. Then, the read/write control unit 102 stores the data in the disk 201 in the storage device in which the data is determined to be stored.

If the virtual storage device 1 receives a read request from the business server 3, the cache management unit 103 receives, from the read/write control unit 102, an input of an acquisition request for the data requested by the read request. Then, the cache management unit 103 searches the cache 104 and determines whether the data requested by the read request is stored in the cache 104.

If the data requested by the read request is stored in the cache 104, the cache management unit 103 acquires the data requested by the read request from the cache 104. Then, the cache management unit 103 outputs the acquired data to the read/write control unit 102. Furthermore, the cache management unit 103 determines, from the migration target data table 160, whether the data requested by the read request is the migration target data. If the data requested by the read request is migration target data, the cache management unit 103 updates the time stamp of the data that is requested by the read request and that is stored in the migration target data table 160 to the date and time at that time. Furthermore, the cache management unit 103 updates the time stamp held by the cache 104 related to the data requested by the read request to the date and time at that time.

In contrast, if the data requested by the read request is not stored in the cache 104, the cache management unit 103 outputs an error response to the read/write control unit 102. Then, the cache management unit 103 acquires, from the read/write control unit 102, the data requested by the read request together with an instruction to store the data in the cache 104.

Then, the cache management unit 103 determines, by using the migration target data table 160, whether the data requested by the read request is the migration target data. In a description below, the data that is not the migration target data may sometimes be referred to as “non-migration target data”. If the data requested by the read request is the non-migration target data, the cache management unit 103 determines whether free space is present in the cache 104. If free space is present in the cache 104, the cache management unit 103 writes the data requested by the read request to the cache 104.

In contrast, if free space is not present in the cache 104, the cache management unit 103 deletes the data with the oldest time stamp from among the pieces of the non-migration target data stored in the cache 104. Consequently, the cache management unit 103 creates a free area in the cache 104. Then, the cache management unit 103 writes the data that is requested by the read request and that is the non-migration target data to the cache 104. At this time, the cache management unit 103 registers, in the cache 104 as the time stamp, the date and time in which the data requested by the read request is written.

In contrast, the cache management unit 103 previously has the upper limit of an amount of migration target data that can be stored in the cache 104. Here, the upper limit of an amount of migration target data that can be stored in the cache 104 is preferably determined from the capacity of the cache 104, the hit rate of the cache 104 to be obtained, the time needed to migrate the data, and the like. For example, if the upper limit is set to high, the data can be migrated at a high speed; however, because the amount of non-migration target data that can be stored is decreased, the hit rate of the cache 104 may possibly be decreased. Furthermore, if the cache 104 is large, the upper limit can be set to high without decreasing the hit rate of the cache 104. Furthermore, it may possibly take time to migrate the migration target data after the migration target data has been copied to the cache 104. Thus, the upper limit of the migration target data that can be stored in the cache 104 is preferably set such that too much influence is not exerted on the normal use of the cache 104. For example, the upper limit of the migration target data that can be stored in the cache 104 is determined to be 30% of the capacity of the cache 104.

Then, if the data requested by the read request is the migration target data, the cache management unit 103 determines whether the migration target data stored in the cache 104 reaches the upper limit. If the data does not reach the upper limit, the cache management unit 103 determines whether free space is present in the cache 104. If the free space is present in the cache 104, the cache management unit 103 writes, to the cache 104, the data that is requested by the read request and that is the migration target data. Furthermore, the cache management unit 103 registers the date and time at the subject time point as the time stamp of the data that is requested by the read request and that is stored in the migration target data table 160 and sets the cache holding flag to 1. Furthermore, the cache management unit 103 registers, in the cache 104 as the time stamp, the date and time in which the data requested by the read request is written.

In contrast, if free space is not present in the cache 104, the cache management unit 103 deletes the data with the oldest time stamp from among the pieces of the non-migration target data stored in the cache 104. Consequently, the cache management unit 103 creates a free area in the cache 104. Then, the cache management unit 103 writes, to the cache 104, the data that is requested by the read request and that is the migration target data. Furthermore, the cache management unit 103 registers date and time at the subject time point as the time stamp of the data that is requested by the read request and that is stored in the migration target data table 160 and sets the cache holding flag to 1. Furthermore, the cache management unit 103 registers, in the cache 104 as the time stamp, the date and time in which the data requested by the read request is written.

In contrast, if the migration target data stored in the cache 104 reaches the upper limit, the cache management unit 103 selects, from the migration target data table 160, the data with the oldest time stamp from among the pieces of data in which the cache holding flag is set. Then, the cache management unit 103 sets the cache holding flag related to the specified data in the migration target data table 160 to “0”, i.e., deletes the cache holding flag. Then, the cache management unit 103 deletes the specified data that is the migration target data from the cache 104. Thereafter, the cache management unit 103 writes the data that is requested by the read request that is the migration target data to the cache 104. Furthermore, the cache management unit 103 sets the date and time at the subject time point as the time stamp of the data that is requested by the read request and that is stored in the migration target data table 160 and sets the cache holding flag to 1. Furthermore, the cache management unit 103 registers, in the cache 104 as the time stamp, the date and time in which the data requested by the read request is written.

Furthermore, the cache management unit 103 receives, from a determination unit 152 in the migration processing unit 105, an instruction to delete the oldest non-migration target data at the time of relocation of the data from the cache 104. Specifically, as will be described in detail later, the cache management unit 103 receives this instruction if the migration target data that is not stored in the cache 104 is present, if free space is not present in the cache 104, and if the non-migration target data is stored. Then, the cache management unit 103 specifies the oldest non-migration target data from the time stamp registered in the cache 104 and deletes the specified non-migration target data. Then, the cache management unit 103 outputs a response indicating that the deletion has been completed to the determination unit 152 in the migration processing unit 105. The cache management unit 103 mentioned here corresponds to an example of a “management unit”.

The load determination unit 107 previously includes a threshold of the processing load that is used to determine the start of the migration process. The threshold of the processing load mentioned here corresponds to an example of a “predetermined value”. The load determination unit 107 monitors a reading/writing process performed by the read/write control unit 102 and measures the processing load of the virtual storage device 1. Here, the processing load of the virtual storage device 1 can be measured by the processing load of the storage devices 21 to 23. Then, the load determination unit 107 compares the measured processing load of the virtual storage device 1 with the threshold. If the measured processing load becomes less than the threshold, the load determination unit 107 determines that a low load is applied to the virtual storage device 1 and then instructs the migration processing unit 105 to start the migration process.

For example, the load determination unit 107 stores therein the threshold of the processing load to be 10% for 10 minutes. Then, if a state in which the band usage rate of the storage devices 21 to 23 falls below 10% is continued for 10 minutes, the load determination unit 107 determines that the virtual storage device 1 is in a low load state. Furthermore, if the processing load does not fall below the threshold even after predetermined time period has elapsed, the load determination unit 107 may be configured such that the processing load is set to be increased. For example, if the processing load does not fall below the threshold even in the state in which the threshold is 10%, the load determination unit 107 may also increase the processing load by, for example, 10% and set the processing load to 20%.

Then, the load determination unit 107 continuously monitors the read/write process performed by the read/write control unit 102 and, if the processing load of the virtual storage device 1 becomes equal to or greater than the threshold, the load determination unit 107 notifies the migration processing unit 105 of an increase in the processing load of the virtual storage device 1.

If the virtual storage device 1 is in the low load state, the migration processing unit 105 receives an instruction to start the migration process from the load determination unit 107. Then, the migration processing unit 105 migrates the data from the storage device 21 that is the migration source storage device to the storage device 24 that is the migration destination storage device and then relocates the data. In the following, the migration processing unit 105 will be described in detail. The migration processing unit 105 includes a reading unit 151, the determination unit 152, and a writing unit 153.

When receiving an instruction to start the migration process, the determination unit 152 refers to the migration target data table 160 and determines whether the migration target data is present. If the migration target data is not present, the determination unit 152 ends the process of relocating the data.

In contrast, if the migration target data is present, the determination unit 152 determines whether the migration target data with no cache holding flag is present in the migration target data table 160. If the migration target data with no cache holding flag is not present, the determination unit 152 instructs the writing unit 153 to write the data.

In contrast, if the migration target data with no cache holding flag is present, the determination unit 152 selects, from the migration target data table 160, the data in which the cache holding flag is not set and the time stamp is the oldest. Then, the determination unit 152 instructs the reading unit 151 to read the selected data. Thereafter, the determination unit 152 receives a response indicating that the reading has been completed from the reading unit 151. Then, the determination unit 152 determines whether free space is present in the cache 104. If free space is present in the cache 104, the determination unit 152 instructs the reading unit 151 to write the read data to the cache 104.

In contrast, if free space is not present in the cache 104, the determination unit 152 instructs the cache management unit 103 to delete the non-migration target data. Then, the determination unit 152 receives a response indicating that the deletion has been completed from the cache management unit 103. Then, the determination unit 152 instructs the reading unit 151 to write the read data to the cache 104. Thereafter, the determination unit 152 receives, from the reading unit 151, a response of the completion of the writing to the cache 104.

After the writing of migration target data with the oldest time stamp to the cache 104 has been completed, the determination unit 152 again determines whether free space is present in the cache 104. If free space is not present in the cache 104, the determination unit 152 determines whether the non-migration target data is present in the cache 104. If the non-migration target data is not present in the cache 104, i.e., if the cache 104 is filled with the migration target data, the determination unit 152 instructs the writing unit 153 to write the data.

In contrast, if free space or the non-migration target data is present in the cache 104, the determination unit 152 repeatedly determines the presence/absence of the migration target data that is not stored in the cache 104 and repeatedly writes the migration target data with the oldest time stamp to the cache 104. Namely, the cache 104 moves the migration target data from the storage device 21 to the cache 104 in chronological order of the time stamp until the cache 104 is filled with the migration target data. Then, if the cache 104 is filled with the migration target data, the determination unit 152 instructs the writing unit 153 to write the data.

Then, the determination unit 152 receives a response of the completion of the writing from the writing unit 153. Then, the determination unit 152 repeatedly determines the presence/absence of the migration target data that is not stored in the cache 104 and repeatedly writes the migration target data with the oldest time stamp to the cache 104 until the migration target data is not present. However, if the load determination unit 107 receives a notification of an increase in the load, the determination unit 152 ends the process of relocating the data.

The reading unit 151 receives, from the determination unit 152, an instruction to read the migration target data in which the cache holding flag is not set and that has the oldest time stamp in the migration target data table 160. Then, the reading unit 151 reads the instructed data from the storage device 21 that is the migration source storage device. Then, the reading unit 151 outputs a response of the completion of the reading to the determination unit 152.

Thereafter, the reading unit 151 receives an instruction to write the read data from the determination unit 152. Then, the reading unit 151 writes the read data to the cache 104. Furthermore, the reading unit 151 registers the date and time at the subject time point as the time stamp of the written data in the migration target data table 160 and sets the cache holding flag to 1. Furthermore, the cache management unit 103 registers, in the cache 104 as the time stamp, the date and time in which the data is written. Then, the reading unit 151 outputs a response of the completion of the writing to the determination unit 152.

If the cache 104 is filled with the migration target data or the migration target data that is not written to the cache 104 is not present, the writing unit 153 receives an instruction to write the data from the determination unit 152. Then, the writing unit 153 writes all of the pieces of the migration target data in the cache 104 to the storage device 24 that is the migration destination storage device. Furthermore, the writing unit 153 deletes the data written to the storage device 24 from the storage device 21. Furthermore, the writing unit 153 deletes, from the migration target data table 160, the information on the data written to the storage device 24. Then, the writing unit 153 outputs, to the determination unit 152, a response of the completion of the writing.

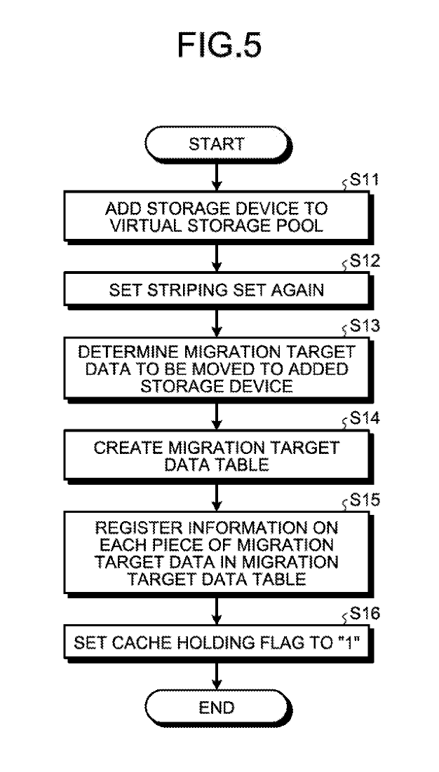

In the following, the flow of creating the migration target data table 160 performed by the virtual storage device 1 will be described with reference to FIG. 5. FIG. 5 is a flowchart illustrating the flow of a process of creating the migration target data table performed by the virtual storage device according to an embodiment.

The storage device 24 is added to the storage system 100. The disk management unit 101 in the virtual storage device 1 adds the added storage device 24 to the virtual storage pool 200 (Step S11).

Then, the disk management unit 101 again sets the striping set 202 that uses the disks 201 included in the storage devices 21 and 24 that is associated with the striping set 202 constructed by the disks 201 included in the storage device 21 (Step S12).

Then, the disk management unit 101 determines, from among the pieces of data stored in the striping set 202 that is used before the storage device 24 is added, the migration target data that is to be moved to the storage device 24 that constructs the reestablished striping set 202 (Step S13).

Then, the disk management unit 101 creates the migration target data table 160 that includes therein the items, such as the storage identification information, the disk identification information, the offset, the time stamp, the flag, or the like (Step S14). At this time, information is not registered in the migration target data table 160.

Then, the disk management unit 101 creates, in the migration target data table 160, a record associated with each of the pieces of the determined migration target data and registers the information, such as the storage identification information, the disk identification information, the offset, the time stamp, the flag, and the like. Then, the disk management unit 101 allows the storage unit 106 to store the migration target data table 160 (Step S15).

Then, the cache management unit 103 acquires, from the migration target data table 160, the information, such as the storage identification information on the migration target data, the disk identification information, the offset, and the like. Then, the cache management unit 103 searches the cache 104 by using the acquired information, specifies the matched migration target data, and sets the cache holding flag of the specified migration target data to “1” (Step S16).

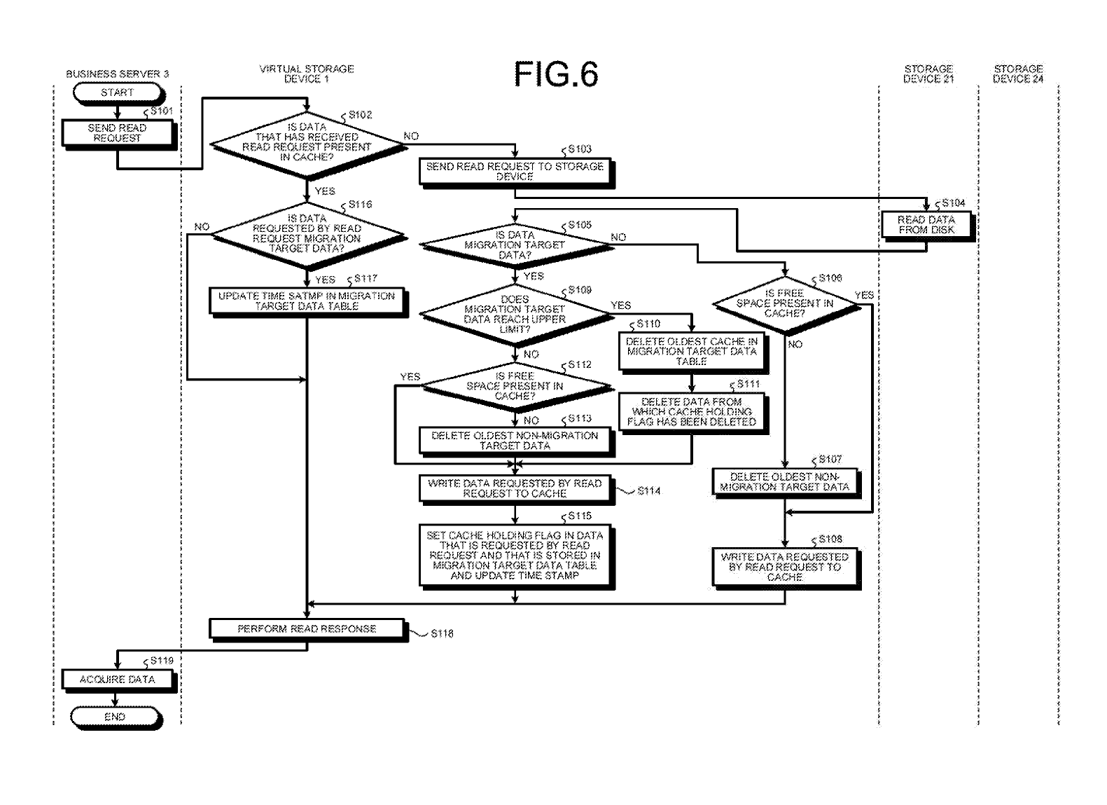

In the following, the flow of the process performed in the storage system 100 when the read request is generated will be described with reference to FIG. 6. FIG. 6 is a processing sequence diagram in the storage system according to the embodiment when a read request is generated.

The business server 3 sends a read request for data to the read/write control unit 102 in the virtual storage device 1 (Step S101).

The read/write control unit 102 receives the read request for the data from the business server 3. Then, the read/write control unit 102 instructs the cache management unit 103 to read, from the cache 104, the data requested by the read request. In response to the instruction to read, from the cache 104, the data requested by the read request, the cache management unit 103 determines whether the data that has received the read request is present in the cache 104 (Step S102).

If the data requested by the read request is not present in the cache 104 (No at Step S102), the cache management unit 103 outputs an error response to the read/write control unit 102. In response to the error response, the read/write control unit 102 sends the read request to the storage device 21 (Step S103). Here, a description will be given of a case in which the data requested by the read request is stored in the storage device 21. However, in also a case in which the data requested by the read request is present in the storage device 24, the storage device that reads the data is only changed and the storage system 100 performs the same process as that indicated by the flow illustrated in FIG. 5.

The storage device 21 receives the read request from the read/write control unit 102. Then, the storage device 21 reads the data designated by the read request from the disk 201 (Step S104). Then, the storage device 21 sends the read data to the read/write control unit 102.

The read/write control unit 102 receives the data requested by the read request from the storage device 21. Then, the read/write control unit 102 instructs the cache management unit 103 to write the data requested by the read request to the cache. The cache management unit 103 determines, by using the migration target data table 160, whether the data requested by the read request is the migration target data (Step S105). It the data requested by the read request is not the migration target data (No at Step S105), the cache management unit 103 determines whether free space is present in the cache 104 (Step S106).

If free space is present in the cache 104 (Yes at Step S106), the cache management unit 103 proceeds to Step S108. In contrast, if free space is not present in the cache 104 (No at Step S106), the cache management unit 103 specifies the oldest non-migration target data on the basis of the time stamps registered in the cache 104 and deletes the specified non-migration target data (Step S107).

Then, the cache management unit 103 writes the data requested by the read request to the cache 104 (Step S108). Thereafter, the virtual storage device 1 proceeds to Step S118.

In contrast, if the data requested by the read request is the migration target data (Yes at Step S105), the cache management unit 103 determines whether the migration target data stored in the cache 104 reaches the upper limit (Step S109).

If the migration target data reaches the upper limit (Yes at Step S109), the cache management unit 103 specifies the migration target data with the oldest time stamp from among the pieces of data that are stored in the migration target data table 160 and that have a cache holding flag. Then, the cache management unit 103 deletes the cache holding flag of the specified migration target data in the migration target data table 160, i.e., the oldest cache holding flag (Step S110). Then, the cache management unit 103 deletes, from the cache 104, the migration target data from which the cache holding flag has been deleted (Step S111). Then, the cache management unit 103 proceeds to Step S114.

In contrast, if the migration target data does not reach the upper limit (No at Step S109), the cache management unit 103 determines whether free space is present in the cache 104 (Step S112). If free space is present in the cache (Yes at Step S112), the cache management unit 103 proceeds to Step S114. In contrast, if free space is not present in the cache (No at Step S112), the cache management unit 103 specifies the oldest non-migration target data on the basis of the time stamps stored in the cache 104 and deletes the specified non-migration target data from the cache 104 (Step S113).

Then, the cache management unit 103 writes the data requested by the read request to the cache 104 (Step S114).

Furthermore, the cache management unit 103 sets the cache holding flag in the data that is requested by the read request and that is stored in the migration target data table 160 and updates the time stamp (Step S115). Then, the virtual storage device 1 proceeds to Step S118.

In contrast, if the data requested by the read request is present in the cache 104 (Yes at Step S102), the cache management unit 103 determines whether the data requested by the read request is the migration target data (Step S116).

If the data requested by the read request is not the migration target data (No at Step S116), the virtual storage device 1 proceeds to Step S118. In contrast, if the data requested by the read request is the migration target data (Yes at Step S116), the cache management unit 103 rewrites the time stamp of the data requested by the read request to the current time and updates the migration target data table 160 (Step S117).

The read/write control unit 102 sends the data that is requested by the read request and that is received from the storage device 21 to the business server 3 and performs a read response (Step S118).

The business server 3 acquires the data requested by the read request from the read/write control unit 102 (Step S119).

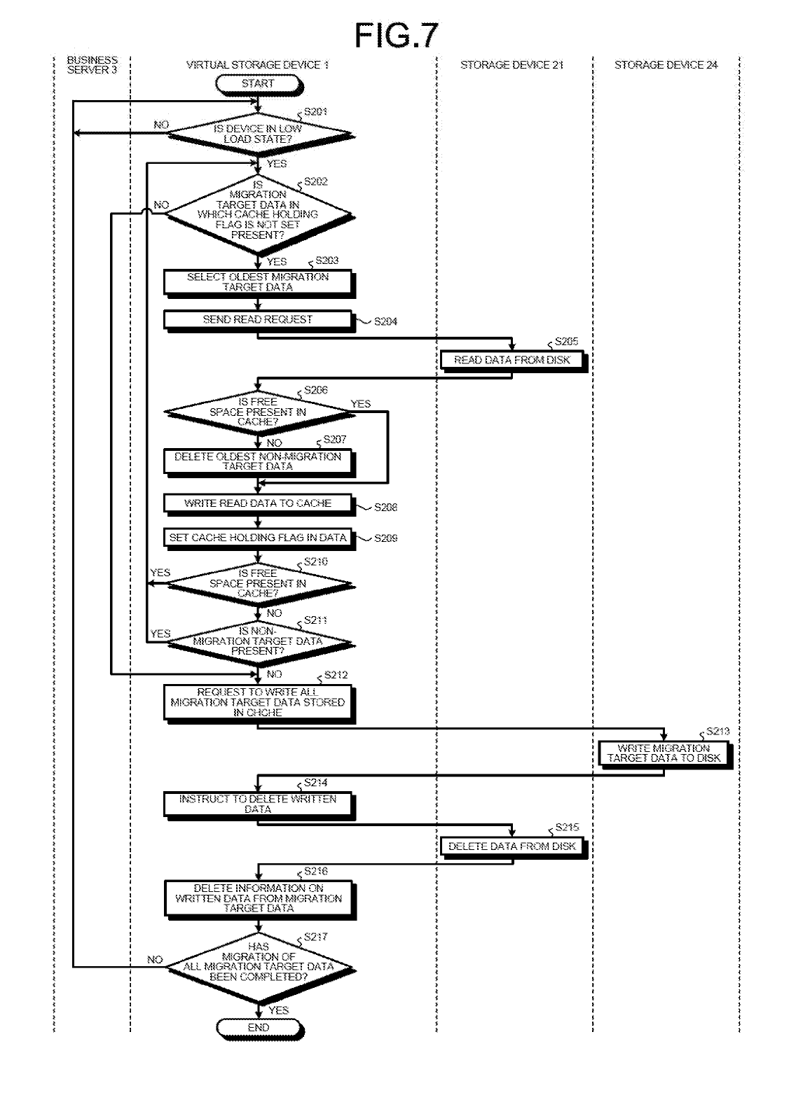

In the following, the flow of a process of relocating data performed in the storage system 100 according to the embodiment will be described with reference to FIG. 7. FIG. 7 is a processing sequence diagram of data relocation performed in the storage system according to the embodiment.

The load determination unit 107 monitors the read/write process performed by the read/write control unit 102 and measures the processing load of the virtual storage device 1. Then, the load determination unit 107 determines whether the processing load of the virtual storage device 1 is less than the threshold and the virtual storage device 1 is in a low load state (Step S201). If the virtual storage device 1 is not in a low load state (No at Step S201), the load determination unit 107 waits until the virtual storage device 1 becomes in a low load state and stops relocating the data.

In contrast, if the virtual storage device 1 is in a low load state (Yes at Step S201), the load determination unit 107 notifies the migration processing unit 105 of the execution of the relocation of the data. If the notification of the execution of the relocation of the data is received, the determination unit 152 determines whether the migration target data with no cache holding flag is present in the migration target data table 160 (Step S202). If the migration target data with no cache holding flag is not present (No at Step S202), the determination unit 152 proceeds to Step S212.

In contrast, if the migration target data with no cache holding flag is present (Yes at Step S202), the determination unit 152 selects the migration target data with the oldest time stamp from the migration target data table 160 (Step S203).

Then, the determination unit 152 instructs the reading unit 151 to read the selected data. In response to the instruction to read the data, the reading unit 151 sends the read request for the migration target data with the oldest time stamp in the migration target data table 160 to the storage device 21 that is the migration source storage device (Step S204).

The storage device 21 receives the read request for the data from the reading unit 151. Then, the storage device 21 reads, from the disk 201, the data designated by the read request (Step S205). Then, the storage device 21 sends the read data to the reading unit 151 in the virtual storage device 1.

The reading unit 151 in the virtual storage device 1 receives, from the storage device 21, the migration target data with the oldest time stamp in the migration target data table 160. Then, the reading unit 151 outputs a response of the completion of the reading of the data to the determination unit 152. In response to the response of the completion of the reading of the data, the determination unit 152 determines whether free space is present in the cache 104 (Step S206). If free space is present in the cache 104 (Yes at Step S206), the determination unit 152 proceeds to Step S208.

In contrast, if free space is not present in the cache 104 (No at Step S206), the determination unit 152 instructs the cache management unit 103 to delete the oldest non-migration target data. In response to the instruction to delete the oldest non-migration target data, the cache management unit 103 specifies the oldest non-migration target data on the basis of the time stamps registered in the cache 104 and deletes the specified non-migration target data (Step S207). Then, the cache management unit 103 outputs a response of the completion of the deletion of the data to the determination unit 152. In response to the completion of the deletion of the data, the determination unit 152 proceeds to Step S208.

Then, the determination unit 152 instructs the reading unit 151 to write the data to the cache 104. In response to the instruction to write the data, the reading unit 151 writes the data read from the storage device 21 to the cache 104 (Step S208).

Furthermore, the reading unit 151 sets the cache holding flag in the data that is written to the cache 104 in the migration target data table 160 (Step S209). Then, the reading unit 151 outputs, to the determination unit 152, a response of the completion of the writing.

When the determination unit 152 receives the response of the completion of the writing from the reading unit 151, the determination unit 152 determines whether free space is further present in the cache 104 (Step S210). If free space is present in the cache 104 (Yes at Step S210), the determination unit 152 returns to Step S202.

In contrast, if free space is not present in the cache 104 (No at Step S210), the determination unit 152 determines whether the non-migration target data is present in the cache 104 (Step S211). If the non-migration target data is present in the cache 104 (Yes at Step S211), the determination unit 152 returns to Step S202. In contrast, if the non-migration target data is not present in the cache 104 (No at Step S211), the determination unit 152 proceeds to Step S212.

The determination unit 152 instructs the writing unit 153 to write the data. In response to the instruction to write the data, the writing unit 153 sends a write request for all of the pieces of the migration target data stored in the cache 104 to the storage device 24 that is the migration destination storage device (Step S212).

In response to the write request for the migration target data received form the determination unit 152, the storage device 24 writes the migration target data stored in the cache 104 to the disk 201 (Step S213).

Then, the writing unit 153 sends, to the storage device 21, an instruction to delete the data that is the read source of the migration target data that has been written to the storage device 24 (Step S214).

In response to the instruction to delete the migration target data, the storage device 21 deletes the designated data from the disk 201 (Step S215).

Then, the writing unit 153 deletes the information on the data written to the storage device 24 from the migration target data table 160 (Step S216). Thereafter, the writing unit 153 outputs, to the determination unit 152, the response of the completion of the writing.

In response to the response of the completion of the writing, the determination unit 152 checks the migration target data table 160 and determines whether the migration of all of the pieces of the migration target data has been completed (Step S217). If the migration target data that has not been migrated remains (No at Step S217), the determination unit 152 returns to Step S201. In contrast, if the migration of all of the pieces of the migration target data have been completed (Yes at Step S217), the determination unit 152 ends the process of relocating the data.

Hardware Configuration

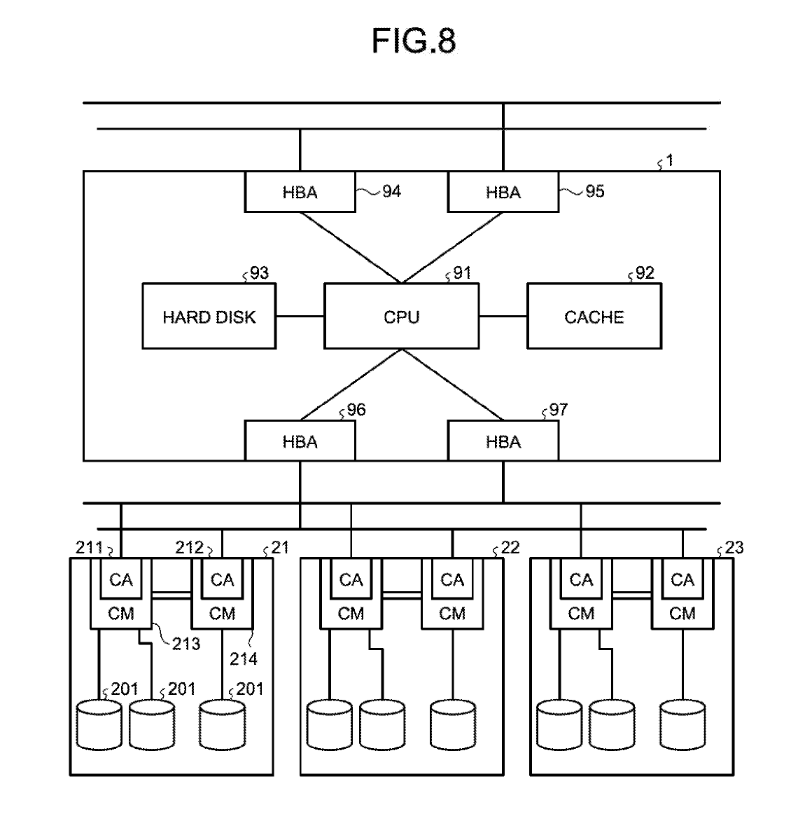

FIG. 8 is a schematic diagram illustrating the hardware configuration of the virtual storage device. As illustrated in FIG. 8, the virtual storage device 1 includes a central processing unit (CPU) 91, a cache 92, a hard disk 93, and host bus adaptors (HBAs) 94 to 97. Furthermore, the storage device 21 includes channel adaptors (CAs) 211 and 212, controller modules (CMs) 213 and 214, and the disk 201. The storage devices 22 and 23 also have the same configuration as that of the storage device 21. The CPU 91 is connected to the cache 92, the hard disk 93, and the HBAs 94 to 97 by a bus.

The HBAs 94 and 95 are interfaces for connecting to the business server 3. Here, both the virtual storage device 1 and the business server 3 include duplexed connection paths and have a failure system. The CPU 91 sends and receives data to and from the business server 3 via the HBAs 94 and 95.

The HBAs 96 and 97 are interfaces for connecting to the storage devices 21 to 23. Here, both the virtual storage device 1 and the storage devices 21 to 23 include duplexed connection paths and have a failure system. The CPU 91 sends and receives data to and from the storage devices 21 to 23 via the HBAs 96 and 97.

The cache 92 implements the function of the cache 104 illustrated in FIG. 3 as an example. Furthermore, the hard disk 93 implements the function of the storage unit 106. Furthermore, the hard disk 93 includes various kinds of programs including the program for implementing the function of the disk management unit 101, the read/write control unit 102, the cache management unit 103, the migration processing unit 105, and the load determination unit 107 illustrated in FIG. 3 as an example.

The CPU 91 uses the hard disk 93 and the cache 92 and implements the function of the disk management unit 101, the read/write control unit 102, the cache management unit 103, the migration processing unit 105, and the load determination unit 107 illustrated in FIG. 3 as an example.

Specifically, the CPU 91 reads various kinds of programs including the programs that implement the functions of the disk management unit 101, the read/write control unit 102, the cache management unit 103, the migration processing unit 105, and the load determination unit 107 stored in the hard disk 93. Then, by executing the various kinds of read programs, the CPU 91 implements the function of the disk management unit 101, the read/write control unit 102, the cache management unit 103, the migration processing unit 105, and the load determination unit 107.

As described above, the virtual storage device according to the embodiment relocates data by writing the migration target data stored in a cache at the time of read process to the migration source storage device. Furthermore, regarding the migration target data that is not present in the cache, the virtual storage device relocates the pieces of data in chronological order of the access date and time. Consequently, regarding the migration target data that is frequently accessed and that has a high possibility of being referred to again and being stored in the cache, relocation of the data is performed by using a process of storing the data in the cache when a read request is generated. Furthermore, regarding the data that is less frequently accessed and that has a low possibility of being stored in the cache, relocation of the data is performed without waiting for the read request. Thus, it is possible to relocate all of the pieces of the migration target data while efficiently using the read process and it is possible to reduce the time taken to relocate the data while suppressing the network load.

According to an aspect of an embodiment of the information processing apparatus, the storage system, the information processing program, and the information processing method disclosed in the present invention, an advantage is provided in that it is possible to reduce the time to relocate data.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing apparatus comprising:
a cache that holds, until a predetermined condition is satisfied, read data which is read, on the basis of a read request, from a migration source storage device which has data including migration target data;
a storage unit that stores therein migration information which includes identification information and access date and time related to the migration target data;
a reading unit that reads, on the basis of the migration information, the migration target data from the migration source storage device in chronological order of the last access date and time and that stores the migration target data in an area in the cache other than an area in which the migration target data has already been stored; and
a writing unit that writes the migration target data stored in the cache to a migration destination storage device.

2. The information processing apparatus according to claim 1, wherein
the writing unit repeatedly deletes the migration target data written to the migration destination storage device from the cache, also repeatedly deletes the migration information related to the migration target data written to the migration destination storage device from the storage unit, and repeatedly writes new migration target data which is again stored in the cache by the reading unit to the migration destination storage device, and
when the writing of the migration target data to the migration destination storage has been completed by the writing unit, the reading unit again reads the new migration target data from the migration source storage device in chronological order of the last access date and time in the migration information and stores the read migration target data in the cache.

3. The information processing apparatus according to claim 1, wherein the reading unit reads the migration target data when a processing load of the information processing apparatus is equal to or less than a predetermined value.

4. The information processing apparatus according to claim 1, further comprising:
a determination unit that determines whether a free area is present in the cache; and
a management unit that deletes, when the determination unit determines that the free area is not present in the cache and when the migration target data that has not been written to the migration destination storage device and that is not stored in the cache is present in the migration source storage device, data other than the migration target data from the cache and that creates the free area, wherein
the reading unit stores, in the free area, the migration target data which has been read from the migration source storage device.

5. The information processing apparatus according to claim 1, wherein the management unit has an upper limit of the migration target data which is stored in the cache, determines, when the latest read data is the migration target data, whether the migration target data stored in the cache reaches the upper limit, writes, when the migration target data does not reach the upper limit, the latest read data to the cache, deletes, when the migration target data reaches the upper limit, the read data stored in the cache from the cache in chronological order of the access date and time, and writes the latest read data to the cache.

6. The information processing apparatus according to claim 1, wherein
when the read data held by the cache is the migration target data, the management unit adds holding information indicating that the cache holds the read data to the identification information and allows the storage unit to store the read data, and
the reading unit reads data other than data to which the holding information is added from among pieces of read-out data in which the identification information is stored in the storage unit from the migration source storage device in chronological order of the last access date and time.

7. The information processing apparatus according to claim 6, wherein, when the read-out data is the migration target data, the management unit allows the storage unit to store the last read date and time as access information together with the identification information on the read-out data.

8. An information processing method comprising:
holding, until a predetermined condition is satisfied, read data which is read, on the basis of a read request, from a migration source storage device which has data including migration target data;
storing, in a storage unit, migration information which includes identification information and access date and time related to the migration target data;
reading, on the basis of the migration information, the migration target data from the migration source storage device in chronological order of the last access date and time and storing the migration target data in an area in the cache other than an area in which the migration target data has already been stored; and
writing the migration target data stored in the cache to a migration destination storage device.

9. A non-transitory computer-readable recording medium having stored therein an information processing program that causes a computer to execute a process comprising:
holding, until a predetermined condition is satisfied, read data that is read, on the basis of a read request, from a migration source storage device that has data including migration target data;
storing, in a storage unit, migration information that includes identification information and access date and time related to the migration target data;
reading, on the basis of the migration information, the migration target data from the migration source storage device in chronological order of the last access date and time and storing the migration target data in an area in the cache other than an area in which the migration target data has already been stored; and
writing the migration target data stored in the cache to a migration destination storage device.
